(19) United States
(12) Patent Application Publication
(10) Pub. No.: US 2008/0127097 A1
(43) Pub. Date: May 29, 2008

(54) METHOD AND DEVICES FOR URL COMMAND TESTING AND FOR SCENARIO TESTING

(75) Inventors: Song Lin Zhao, Beijing (CN); Jun Hua Wang, Beijing (CN); Bai Chen Deng, Beijing (CN)

Correspondence Address: AKERMAN SENTERFITT, P.O. BOX 3188, WEST PALM BEACH, FL, 33402-3188, US

(73) Assignee: INTERNATIONAL BUSINESS MACHINES CORPORATION, Armonk, NY (US)

(21) Appl. No.: 11/944,570

(22) Filed: Nov. 23, 2007

(30) Foreign Application Priority Data
Nov. 28, 2006 (CN) 200610162753.8

(51) Int. Cl. G06F 9/44

(52) U.S. Cl. 717/124

(57) ABSTRACT

The present invention discloses a testing method of URL command, comprising the steps of: determining the type of said URL command; according to the determined type, adding test data to the URL command to form a test command; sending said test command to a server by using a browser and receiving contents returned from said server; and displaying the returned contents by said browser. The present invention further discloses a scenario testing method by using URL command testing in combination with GUI testing, a device and a system of implementing the above methods.

### CROSS-REFERENCE TO RELATED APPLICATION

This application claims the benefit of Chinese Patent Application No. 200610162753.8, filed on Nov. 28, 2006, the entirety of which is incorporated herein by reference.

### TECHNICAL FIELD

The present invention relates to the field of data processing, and, more particularly to methods and devices for testing software.

### BACKGROUND OF THE INVENTION

Uniform Resource Locator (URL) command testing and Graphical User Interface (GUI) testing are frequently utilized in testing different attributes of software. URL command testing, utilized in a browser/server environment, is directed to the testing of command reception/sending and transmission background between a browser and a server. During URL testing, the user interface is typically transparent. By contrast, GUI testing, a more user-experience-oriented testing method, typically provides a user with the actual user interface of the tested software. Therefore, GUI testing is a testing method commonly used for testing software on a rich client, such as a C++ client, a Java client, or the like.

Both of these testing methods have their inherent advantages and disadvantages. For instance, GUI testing, though providing user-viewable testing results, has relatively poor testing flexibility, as it is usually susceptible to GUI changes between different releases of a product. URL command testing can implement effective testing upon the occurrence of large GUI changes and can, in some respects, make up for the lack of flexibility of GUI testing, as it is insensitive to GUI changes, but URL command testing focuses on the command processing background. Accordingly, a disadvantage of URL command testing is that the user interface of the tested software is not sufficiently visible to users. In traditional URL command testing, since the testing is implemented in the background, users typically merely obtain simple prompts in code lines, but are usually not made visually aware of the underlying process occurring. In order to simulate the interactions between a user and a web application server, URL command testing creates URL test objects that communicate with the host server to request the transmission of a page. Then, the host server will return a plain static HTML source file, whereas other files, such as independent JavaScript file and JavaApplet classes, are typically lost. Therefore, the returned page will usually lose much information. When the returned page was originally composed by complex JavaScripts and Applets, much of the content can be lost. A similar problem also exists in URL testing of other programming languages.

Additionally, with the development of network technology, especially the emergence of e-Commerce, a large number of IT system scenarios that are a composite of rich clients, web applications and application servers are observed in the context of enterprise computing. An example of such is illustrated in FIG. 1. FIG. 1 is a schematic view of a typical e-Commerce work flow scenario. In the work flow, first, a sales manager 101 creates a Telesales Representative (TSR) user account (1011); next, a shopper 102 places three items on the e-Commerce site (1021); then, a TSR 103 is utilized for arranging shipping matters for shopper 102's order within his delegated authority (1031); and finally, shopper 102 can view the complete order information (1041).

As illustrated by the foregoing description of a work flow scenario, the actual work flow of the e-Commerce scenario shown in FIG. 1 is usually a complex end-to-end scenario. Specifically, corresponding to the respective phases in the foregoing work flow, application types at the enterprise level appear as follows: step 1011 is fulfilled by a web application 1, step 1021 is fulfilled by a web application 2, step 1031 is fulfilled by a Telesales client application, and step 1041 is fulfilled by web application 2.

Conventional software testing is typically directed to only one application of one type at a time and can generate only an independent test result for each application individually. Specifically, in a traditional automated testing process, web application 1, web application 2 and the Telesales client application are tested respectively with different test tools. That is, web application 1 and web application 2 are tested with URL command testing tools, whereas the Telesales client application is tested with GUI testing tools.

The multiple applications of different types are involved in a single work flow like the e-Commerce scenario described previously. This brings considerable complexity to the scenario's overall functional testing, as the testing needs to simulate this kind of complex scenario smoothly. On one hand, complex prerequisite test data must be prepared for a sub-system corresponding to each step respectively so as to guarantee an appropriate dovetailing between data steps. On the other hand, there is a need to ensure that the integrated flow after testing step by step works well enough to satisfy the requirement of the production environment. However, it is hard to achieve such a result with the existing test tools and methods.

### SUMMARY OF THE INVENTION

An object of the present invention is to provide a testing method of URL commands capable of visualizing URL testing. The method can include the steps of: determining the type of a URL command; according to the determined type, adding test data to the URL command to form a test command; sending the test command to a server using a browser and receiving contents returned from the server; and displaying the returned contents by the browser.

An aspect of the present invention is a device for URL command testing. The device can include: means of determining a type of a URL command; test command forming means for, according to the determined type, adding test data to the URL command in order to form a test command; and a browser for sending the test command to a server, and for receiving and displaying returned contents from the server.

Based on visualized URL testing, the present invention further provides a scenario testing method for testing the scenario by using URL command testing in combination with GUI testing. The scenario testing method can include the steps of: splitting the scenario into a plurality of tasks in accordance with applications, such that each task corresponds to one application of one type; determining a task type as a URL command test task or a Graphical User Interface test task for each task; executing the testing in the sequence of tasks of the scenario, and performing the testing in accordance with the testing method already described when the task type is the URL command test task, wherein output data of the task is saved for use of subsequent tasks.

To implement the scenario testing method for fine-grained combination described previously, according to another aspect of the present invention, a scenario testing system for testing the scenario by using URL command testing in combination with Graphical User Interface testing is provided. The scenario testing system can include: task splitting means for splitting the scenario into a plurality of tasks in accordance with applications, such that each task corresponds to one application of one type; a task execution engine for determining a task type as a URL command test task or a Graphical User Interface test task for each task, executing the testing in the sequence of tasks of the scenario, and performing the testing in accordance with the testing method already described when the task type is the URL command test task; and a task context engine for saving output data of the task for use of subsequent tasks.

With the methods, the device and the system provided by the present invention, a test result of URL command testing can be presented in the form of a visual display. Moreover, testing of a complex scenario can be effected in a more user-experience-oriented manner by combining URL command testing and GUI testing.

### BRIEF DESCRIPTION ON THE DRAWINGS

The above and other features of the present invention will become more apparent from the detailed description of the embodiments, when taken in conjunction with the accompanying drawings in which like numerals denote the same or similar components. There are shown in the drawings, embodiments which are presently preferred. It is expressly noted, however, that the invention is not limited to the precise arrangements and instrumentalities shown.

FIG. 1 is a schematic view of a typical e-Commerce scenario work flow;

FIG. 2 is a flowchart of exemplary steps for a URL command testing method, according to an embodiment of the present invention;

FIG. 3 is a schematic view of the internal structure of a URL testing device, according to another embodiment of the present invention;

FIG. 4 is a schematic view of respective steps performed by a scenario testing method using URL testing in combination with GUI testing according to an embodiment of the present invention for the scenario shown in FIG. 1;

FIG. 5 is a schematic view of feeding data between tasks, according to another embodiment of the present invention;

FIG. 6 shows a schematic view of a system architecture for implementing a scenario testing method according to yet another embodiment of the present invention; and

FIG. 7 is a schematic view of a computer system for implementing testing procedures, according to an embodiment of the present invention can be implemented.

### DESCRIPTION OF THE PREFERRED EMBODIMENTS

The embodiments of the present invention will be illustrated in detail with reference to the accompanying drawings. It should be noted that specific implementation steps of methods and specific structures of devices shown here are merely illustrative and not intended to limit the present invention.

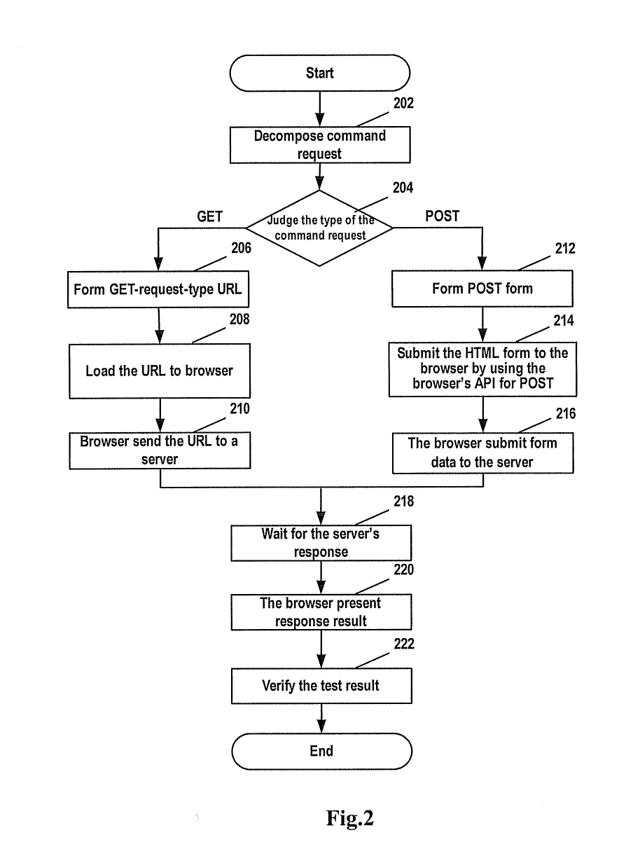

To solve the problems described previously to visually display URL command testing, a URL command testing method according to an embodiment of the present invention interacts with a server by means of a browser, whose flow chart is as shown in FIG. 2. The URL command testing method as shown in FIG. 2 starts. First, in step 202, URL testing code is read, and URL command request code therein is decomposed using multiple decomposing methods known to those skilled in the art. After the decomposition in step 202, the URL command request code is decomposed into the following parts: “URL command,” “command parameters” and “request type.” Among them, “request type” may be a GET type or a POST type.

According to the “request type” part among the several parts decomposed in step 202, a type which the current URL command belongs to is determined in step 204. Then, different processing will be implemented based on the type in subsequent steps shown in FIG. 2.

If it is determined that the current URL command belongs to a GET type, the flow shown in FIG. 2 goes to step 206. In step 206, a hostname, the URL command and test parameters are pieced into a URL (such as http://www.hostname.com: 8000/Command?userId=ABC&storeId=10001&productId=12345) which can be directly used by a browser by appending the hostname and other test parameters (such as host port, user name, store ID, product ID, etc.) of a corresponding server to the URL command request, and thus the URL of GET request type is formed. If necessary, for example, when parameters contain a URL character string pointing to the jump page, in this step the URL is “x-www-form-urlencoded” encoded, such that all non-alphabetic-digital characters except -_. will be replaced by percentage symbol (%) plus two hexadecimal digits.

Afterwards, pieced URL is loaded to the browser as the GET testing command by using API (Application Interface) provided by the browser in step 208, so that the browser accesses the URL and sends the URL command to the server in step 210.

On the other hand, if it is determined in step 204 that the current URL command belongs to POST type, the flow shown in FIG. 2 goes to step 212. In step 212, a URL command and test parameters needed for POST request processing are pieced into a temporary Hypertext Markup Language (HTML) form of POST request type, and thus the form of POST request type is formed. The URL command is a complete URL containing the hostname. An example of a HTML form is provided as follows:

<form action=”http://www.hostname.com:8000/Command”

method=”post”>

<input type=”text” name=”userId” value=”ABC”>
<input type=”text” name=”storeId” value=”10001”>
<input type=”text” name=”productId” value=”12345”>

</form>

Then, the temporary HTML form is automatically submitted to the browser as a POST testing command by using the browser's application interface (API) for POST request type in step 214, and the form data is submitted the server by means of the browser in step 216.

After the GET testing command or the POST testing command is submitted to the server in step 210 or 216, the flow shown in FIG. 2 waits for the server's response in step 218, and upon acquisition of the response, display the response result by using the browser in step 220, so that the URL testing result is displayed in a visualized form. In this way, all the contents will not be lost. For instance, not only the JavaScript and Applet contents but also other information, such as pictures, Flash animations, and the like will not be lost.

Optionally, the test response result returned by the server may be displayed and validated in step 222, so as to reflect whether or not the testing satisfies the requirement. In this step, the server response content, such as a Hypertext Markup Language source is acquired by using the browser's application interface (API), so as to validate by using the visualized page whether or not the returned result conforms to the test requirement. In this validation step, both GUI and content validation methods are supported. In this way, users can choose desired validation methods according to their preference or needs, for example, choose to validate GUI element values and/or validate contents returned by the URL command. The procedure shown in FIG. 2 illustratively ends at this point.

As is clear from the above illustration of the flow shown in FIG. 2, the URL testing method according to an embodiment of the present invention does not directly use those command code forms common in the prior art for testing, but it converts the testing command request into URL that can be identified directly by the browser by using a well known browser or submits a form to the browser by using the browser's application interface and thereby sends/receives the testing command to/from the server by means of the browser. In this way, any response of the server can be visually presented to the user by using the browser, and visualized effects are achieved accordingly.

Visualized testing may also be implemented on web application based on AJAX technique of web2.0 by using the principle of the method described previously. The testing is like the flow shown in FIG. 2. The difference between them in that in this embodiment, the core is to invoke by using test scripts an Extensible Markup Language Hypertext Transfer Protocol Request (XMLHTTPRequest) module of the browser to send a Hypertext Transfer Protocol (HTTP) request the module supports and to dynamically change contents of a page Document Object Model (DOM) tree according to a response. Corresponding to the formation steps 206 and 212 in FIG. 2, the present embodiment will piece the HTTP request the XMLHttpRequest module supports according to the testing needs and subsequently control by using the browser application interface (API) the browser's XMLHttpRequest module to send the above request. The response returned from the server side is acquired by the browser. Thus, the testing on web application based on AJAX technique of web2.0 is implemented in a visualized display way. Validation of the testing is implemented by acquiring the server response content like DOM objects using the browser's application interface (API).

There is no difference between Web2.0 application testing in GUI manner and ordinary GUI testing provided that the test tools can dynamically identify changes of the page's HTML objects.

The browser of the present invention can comprise a traditional browser as well as a composite of the traditional browser and the XMLHttpRequest module.

Those skilled in the art will understand from the above description that the URL testing method according to an embodiment of the present invention may achieve the inventive object by using any proper web browser provided that the browser's corresponding application interface (API) can be learned. Therefore, different types of browsers do not limit the present invention.

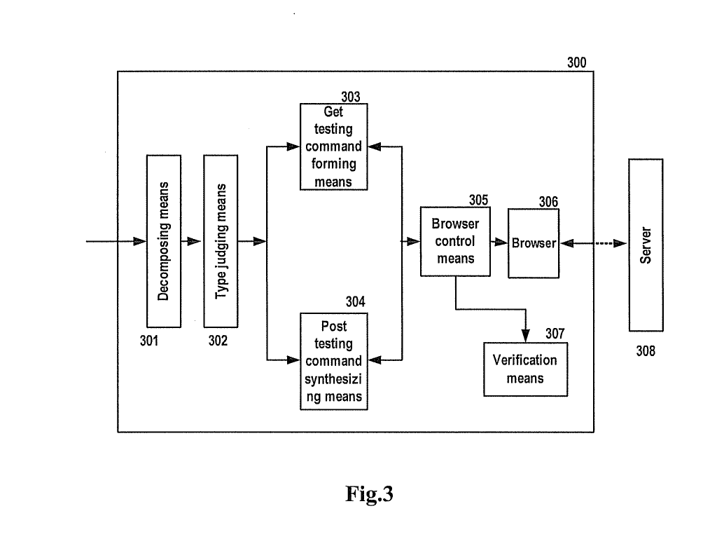

To implement the method shown in FIG. 2, the present invention also provides a URL testing device whose internal structure is as shown in FIG. 3. A URL device 300 according to an embodiment of the present invention comprises: decomposing means 301, type determining means 302, GET testing command forming means 303, POST testing command forming means 304, browser control means 305, a browser 306 and validation means 307.

Hereinafter, operations of and connection relations between the respective means will be illustrated in detail with reference to FIG. 3. Decomposing means 301 reads URL test code and decompose URL command request code by using a plurality of methods known to those skilled in the art. The URL command request code is decomposed into the following parts: “URL command,” “command parameters” and “request type.” Among them, “request type” may be a GET type or POST type.

According to the “request type” part among the several parts after decomposition, type determining means 302 determines a type the current URL command belongs to and performs different processing according to the type.

If it is determined that the current URL command belongs to a GET type, GET testing command forming means 303 appends to the URL command request a hostname and other test parameters (such as host port, user name, store ID, product ID) of a corresponding server, pieces the hostname, the URL command and test parameters into a URL which can be directly used by the browser, and thus forms the URL of GET request type. If necessary, for example, when parameters contain a URL character string pointing to the jump page, GET testing command forming means 303 “x-www-form-urlencoded” encodes the URL, so that all non-alphabetic-digital characters except hyphen (-) underscore (_) and period (.) will be replaced by the percentage symbol (%) plus two hexadecimal digits.

Browser control means 305 loads the pieced URL to browser 306 as the GET testing command by using the application interface (API) of subsequent browser 306 stored in it, so that browser 306 accesses the URL and sends the URL command to the server.

On the other hand, type determining means 302 determines that the current URL command belongs to a POST type, POST testing command forming means 304 pieces a URL command and test parameters needed for POST request processing into a temporary Hypertext Markup Language (HTML) form of POST request type, and thus fulfills the formation of the form of POST request type. The URL command is a complete URL containing the hostname.

Afterwards, browser control means 305 automatically submits the temporary HTML form to browser 306 as a POST testing command by using the application interface (API) of subsequent browser 306 stored in it and submits the form data to the server by means of the browser.

After browser 306 submits the GET testing command or the POST testing command to the server, URL testing device 300 waits for the server's response, and upon acquisition of the response, displays the response result by using browser 306, so that the URL testing result is displayed in a visualized form.

Optionally, validation means 307 may display and validate the test response result returned by the server, so as to reflect whether or not the testing satisfies the requirement. In validation means 307, the server response content, such as a Hypertext Markup Language source is acquired by using the browser's application interface (API), so as to validate by using the visualized page whether or not the returned result conforms to the test requirement. Both GUI and content validation methods are supported in validation means 307. In this way, users can choose desired validation methods according to their preference or needs, for example, choose to validate GUI element values and/or validate contents returned by the URL command.

The above devices may also implement visualized testing on web application based on AJAX technique of web2.0. The difference is that in this embodiment, the core is to invoke by using test scripts an Extensible Markup Language Hypertext Transfer Protocol Request (XMLHTTPRequest) module of browser to send a Hypertext Transfer Protocol (HTTP) request the module supports and to dynamically change contents of a page Document Object Model (DOM) tree according to a response. Corresponding to GET testing command forming means 303 and POST testing command forming means 304 in FIG. 3, the present embodiment will piece the HTTP request the XMLHttpRequest module supports according to the testing needs and subsequently control by using the browser application interface (API) the browser's XMLHttpRequest module to send the above request. The response returned from the server side is acquired by the browser. Thus, the testing on web application based on AJAX technique of web2.0 is implemented in a visualized way. Validation of the testing is implemented by acquiring the server response content like DOM objects using the browser's application interface (API).

There is no difference between Web2.0 application testing in GUI manner and ordinary GUI testing provided that the test tools can dynamically identify changes of the page's HTML objects.

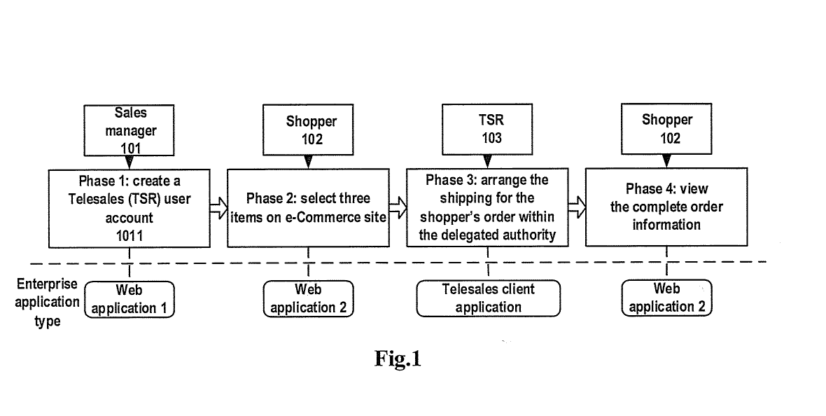

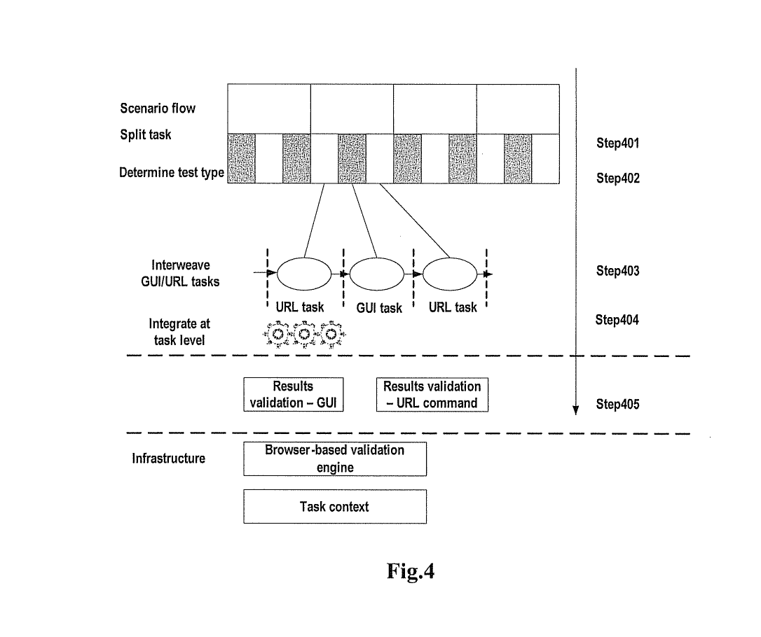

Based on the visualized result from the above testing process, the present invention can further solve the overall testing of the complex scenario having a plurality of applications as shown in FIG. 1 by using URL testing in combination with GUI testing, which will be illustrated in detail with reference to FIGS. 4-6.

Take the scenario shown in FIG. 1 as an example. FIG. 4 shows a schematic view of respective steps performed by a scenario testing method using URL testing in combination with GUI testing according to an embodiment of the present invention. As shown in FIG. 4, first, the scenario testing method according to the present embodiment splits a scenario to be tested into a plurality of tasks in accordance with applications (step 401), so that each task corresponds to only one application of a type. In the present embodiment, the e-Commerce scenario in FIG. 1 is split into four tasks, namely the task of creating a user account (1011), the task of placing an order by the shopper (1021), the task of arranging the shipping (1031) and the task of viewing the order by the shopper (1041). Among them, task 1011 is fulfilled by web application 1, task 1021 by web application 2, task 1031 by the Telesales client application, and task 1041 by web application 2.

On the basis of the tasks splitting, a type of the testing task to be executed is determined for each task (step 402). To achieve flexible portability, the standard for determining task types may be based on the ability to constitute units which are reusable in different scenarios. That is, each task testing must be tailored with a standard common interface irrespective of the application type of a task to be fulfilled. Additionally, whether to execute URL testing or GUI testing is up to the specific requirement of a tested scenario. Users can select the most appropriate test task type after talking into account the characteristics of the application under testing.

For web application testing, both URL testing and GUI testing can be adopted. As for rich client application, GUI testing is usually adopted. Since URL testing according to an embodiment of the present invention has been visualized with the browser, based on the browser, URL testing and GUI testing can be maintained in the same session without a break during the testing of different types. This, as the browser's inherent function, is transparent to users. In this way, according to an embodiment of the present invention, users can freely select desired test types and adopt different types of testing methods for different tasks in the same scenario without considering the problem concerning how to maintain the session.

In the present embodiment, the following test task types are selected for the respective tasks of the work flow in FIG. 1.

1. URL testing—task of creating a user account;

2. GUI testing—task of placing an order by the shopper;

3. GUI testing—task of arranging the shipping;

4. URL testing—task of viewing the order by the shopper.

Then, the method shown in FIG. 4 interweaves GUI/URL test tasks (step 403). In this step, respective tasks of GUI/URL testing are executed in the sequence of the work flow. In the present embodiment, URL testing of the task of creating a user account, GUI testing of the task of placing an order by the shopper, GUI testing of the task of arranging the shipping, and URL testing of the task of viewing the order by the shopper are executed in this sequence. In the embodiment of the present invention, URL testing tasks will be executed using the method shown in FIG. 2, so that URL testing can be displayed in a visualized way.

Hash table, array, cookie or other manners those skilled in the art can conceive may be used to feed a result from each test task to its subsequent task, so that GUI testing and URL testing at the task level are integrated together (step 404). The feeding of test data between tasks will be illustrated in detail.

For the final test result of the scenario testing, the server's final response content such as a Hypertext Markup Language source may be acquired by using the browser's application interface (API), so as to validate by using the visualized page whether or not the returned final result conforms to the overall test requirements of the scenario (step 405). GUI and URL command response results (contents) may be validated at the same time. For instance, it may be validated at the same time if a checkbox is in a check status and string “ABC” is in the html source. Thus, it is validated if the overall testing of the scenario is correct. Then, the scenario testing method shown in FIG. 4 ends. As is clear from the above illustration, the scenario testing method according to an embodiment of the present invention can use URL command testing and GUI testing at the same time during the testing process.

In the scenario testing method shown in FIG. 4, a key step for performing GUI/URL combined testing lies in the accurate feeding of test data between tasks, which will be illustrated in detail with reference to FIG. 5. FIG. 5 shows a schematic view of a method for feeding data between tasks according to an embodiment of the present invention. The data feeding is implemented by saving output data of a previous task for the use of the subsequent task.

The scenario shown schematically comprises a number of tasks, among which there are two successive tasks, namely task 501 called task 1 and task 502 called task 2. Task 1 (501) reads test result data from its previous task (5011). Data of task 1 can be saved in the manner of hash table, array, coolie or other manner those skilled in the art can conceive, and is then read by task 2. Additionally, context information is also a data source task 1 may utilize. The context is used to save some common information for all of the tasks (including URL and GUI testing tasks), such as application server hostname and servlet path. The context information is generated during the environment initialization phase.

Upon acquisition of the data indispensable to the testing, task 1 processes test data by using them (5012), thereby acquiring test result data of task 1. Then, task 1 saves the test result data and feeds them to its subsequent task (5013), namely task 2 (502). Upon reading of the test result data of task 1 and the indispensable context information (5021), task 2 processes its own data (5022) and outputs test result data to its subsequent task (5023), so on and so forth.

Those skilled in the art should understand what is shown in FIG. 5 is merely illustrative and not limiting. In fact, the present invention can use any appropriate means that can achieve the inventive object to feed data between tasks. Different methods for feeding data do not limit the present invention.

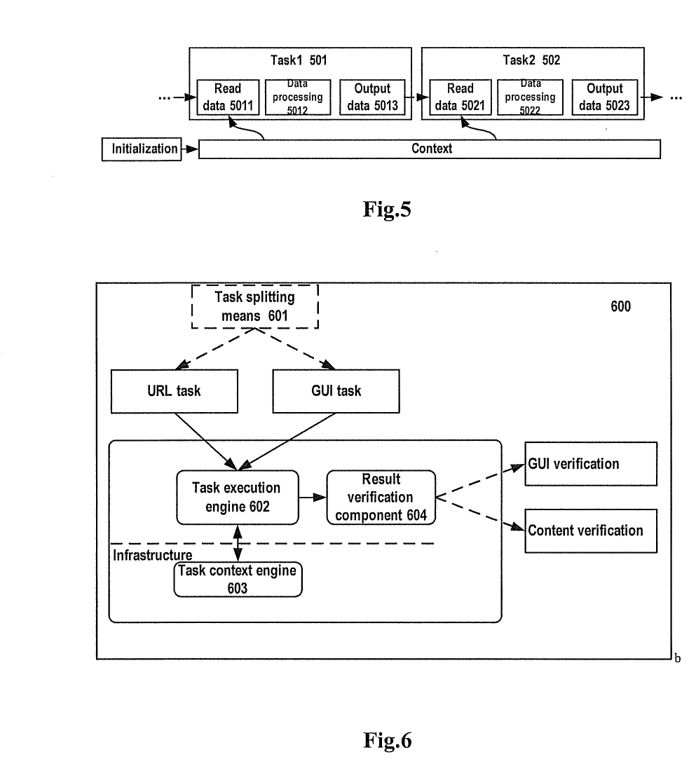

The present invention effectively fulfills the scenario testing in combination of URL testing and GUI testing through the above-described data feeding between tasks. At the same time, in order to implement the scenario testing method, the present invention provides a system architecture specially for executing the scenario testing method, which is as shown in FIG. 6.

A system architecture 600 in FIG. 6 comprises task splitting means 601, a task execution engine 602 and a task context engine 603. Specifically, task splitting means 601 is used to splitting the work flow of a scenario under testing into tasks in accordance with the type of an application. Take the e-Commerce scenario shown in FIG. 1 as an example in the present embodiment. Task splitting means 601 splits the scenario under testing into a plurality of tasks in accordance with the application, so that each task merely corresponds to one application of one type. In the present embodiment, the e-Commerce scenario in FIG. 1 is split into four tasks, namely the task of creating a user account (1011), the task of placing an order by the shopper (1021), the task of arranging the shipping (1031) and the task of viewing the order by the shopper (1041). Among them, task 1011 is fulfilled by web application 1, task 1021 by web application 2, task 1031 by the Telesales client application, and task 1041 by web application 2.

On the basis of the task splitting, task execution engine 602 executes the respective tasks in the sequence of the work flow. Prior to the execution, task execution engine 602 needs to determine a test type of each current task. To achieve flexible portability, the standard for determining test types may be based on the ability to constitute units which are reusable in different scenarios. That is, each test task may be tailored with a standard common interface irrespective of the application type of a task to be fulfilled. Additionally, whether to execute URL testing or GUI testing is up to the specific requirement of a tested scenario.

In the present embodiment, the following test types are selected for the respective tasks of the work flow in FIG. 1.

1. URL testing—task of creating a user account;

2. GUI testing—task of placing an order by the shopper;

3. GUI testing—task of arranging the shipping;

4. URL testing—task of viewing the order by the shopper.

According to the determined test type of the task, task execution engine 602 executes URL testing of the task of creating a user account, GUI testing of the task of placing an order by the shopper, GUI testing of the task of arranging the shipping, and URL testing of the task of viewing the order by the shopper in this sequence. In the embodiment of the present invention, task execution engine 602 comprises the URL testing device as shown in FIG. 3. URL testing tasks will be executed by the URL testing device, so that URL testing can be displayed in a visualized way.

Task context engine 603 is responsible for feeding a result from each test task in task execution engine 602 to its subsequent task such as in the manner of Hash table, array, coolie or other manners those skilled in the art can conceive, so that GUI testing and URL testing at the task level are integrated together.

Optionally, system architecture 600 may further comprise a result verification component 604 for acquiring the server's final response content, such as a Hypertext Markup Language source, with respect with the final test result of the scenario testing by using the browser's application interface (API), so as to verify by using the visualized page whether or not the returned final result conforms to the overall test requirements of the scenario. GUI and URL command response results (contents) may be verified at the same time. For instance, it may be validated at the same time if a checkbox is in a check status and string “ABC” is in the html source. Thus, it can be verified if the overall testing of the scenario is correct. In the integrated system, the verification mechanism is more flexible than the traditional method. Users can verify with both GUI and content verification methods, e.g. can verify if a checkbox is in a check status and string “ABC” is in the html source at the same time. As is clear from the above illustration, the scenario testing system architecture according to an embodiment of the present invention may use URL command testing and GUI testing at the same time during the testing process.

With the methods and devices provided by the present invention, the visualized display of URL command testing is achieved effectively, and overall testing of the scenario can be executed by combining GUI testing and URL command testing on this basis, so that scenario testing for which systematic overall testing can hardly be performed in the prior art can be executed in a more user experience oriented manner. All testing processes executed as such can be visually displayed to end users.

The above embodiments of the present invention can be implemented in a computer system in a centralized manner or a distributed manner. Any type of computer system or other devices that is suitable for implementing the methods described here is suitable for performing the functions described here.

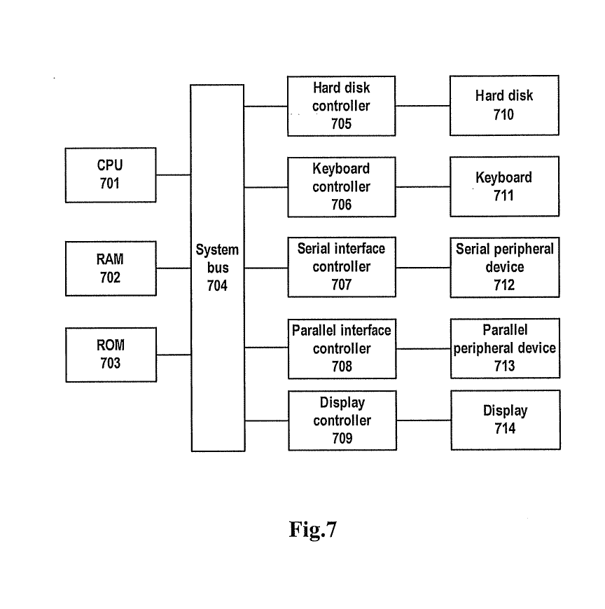

FIG. 7 schematically shows a computer system in which the embodiments according to the present invention can be implemented.

The computer system shown in FIG. 7 comprises a CPU (Central Processing Unit) 701, a RAM (Random Access Memory) 702, a ROM (Read Only Memory) 703, a system bus 704, a HD (Hard Disk) controller 705, a keyboard controller 706, a serial interface controller 707, a parallel interface controller 708, a display controller 709, a hard disk 710, a keyboard 711, a serial external device 712, a parallel external device 713 and a display 714. Among these components, connected to system bus 704 are CPU 701, RAM 702, ROM 703, HD controller 705, keyboard controller 706, serial interface controller 707, parallel interface controller 708 and display controller 709. Hard disk 710 is connected to HD controller 705, and keyboard 711 to keyboard controller 706, serial external device 712 to serial interface controller 707, parallel external device 713 to parallel interface controller 708, and display 714 to display controller 709.

The functions of each component in FIG. 7 are well known in the art, and the architecture shown in FIG. 7 is conventional. Such an architecture applies to not only personal computers but also handheld devices such as Palm PCs, PDAs (personal data assistants), mobile telephones, etc. In different applications, some of the components shown in FIG. 7 may be omitted. The whole system shown in FIG. 7 is controlled by computer readable instructions, which are usually stored as software in hard disk 710, EPROM or other non-volatile memory. The software can also be downloaded from the network (not shown in the figure). The software, either saved in hard disk 710 or downloaded from the network, can be loaded into RAM 702, and executed by CPU 701 for implementing the functions defined by the software.

As the computer system shown in FIG. 7 is able to support the URL testing method and the scenario testing method according to the present invention, the computer system merely serves as an example of computer systems. Those skilled in the art may understand that many other computer system designs are also able to carry out the embodiments of the present invention.

The present invention may further be implemented as a computer program product used by, for example, the computer system shown in FIG. 7, which contains code for implementing the URL testing method and the scenario testing method according to the present invention. Thus the code can be embedded in a computer-readable storage medium that when loaded and executed by a computer causes the computer to perform various procedures described herein. Accordingly, the code may be stored in a memory of other computer system prior to the usage. For instance, the code may be stored in a hard disk or a removable memory like an optical disk or a floppy disk, or may be downloaded via the Internet or other computer network.

The disclosed methods of the present invention may be implemented by software, hardware, or a combination thereof. The hardware part can be implemented by using a special logic, and the software part can be stored in a memory and executed by an appropriate instruction execution system, such as a microprocessor, a personal computer (PC) or a mainframe.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadcast interpretation so as to encompass all such modifications and equivalent structures and functions.

We claim:

1. A method of testing Uniform Resource Locator (URL) commands, the method comprising the steps of:
determining a type of a URL command;
according to the determined type, adding test data to the URL command to form a test command;
sending said test command to a server using a browser and receiving contents returned from said server; and
displaying the returned contents using said browser.

2. The method according to claim 1, wherein said step of determining the type of said URL command comprises the steps of:
decomposing command request code of said URL command; and
according to a request type obtained from said decomposition, determining whether the type of said URL command is a GET type or a POST type.

3. The method according to claim 2, wherein said step of adding test data to form a test command comprises:
when it is determined that said URL command is a GET type, appending to the URL command test parameters and a hostname of a corresponding server, assembling the parameters and hostname into a URL command which can be directly used as said GET test command by said browser and loading it to said browser; and
when it is determined that said URL command is a POST type, submitting a POST type form into which the test data is assembled to said browser as said POST test command using an application interface of said browser for said POST type.

4. The method according to claim 3, wherein said step of processing POST type comprises the steps of:
assembling said POST-type URL command and test parameters into a temporary HTML form of POST request type; and
automatically submitting said temporary HTML form to the browser using said application interface for POST request type,
wherein said POST type URL command contains a URL in which the hostname is complete.

5. The method according to claim 1, further comprising a verification step for acquiring said server response content using an application interface of said browser, so as to verify using a display of said browser whether the returned result conforms to the test requirement.

6. The method according to claim 5, wherein said verification step comprises at least one of URL command verification and Graphical User Interface verification.

7. The method according to claim 1, wherein said step of adding test data to form a test command adds the test data to form an HTTP request which an XMLHTTPRequest module in said browser can support.

8. The testing method according to claim 7, wherein said step of sending said test command to said server and receiving contents returned from said server using said browser comprises sending, using the XMLHTTPRequest module, an HTTP request which said XMLHTTPRequest module can support.

9. A testing device of Uniform Resource Locator (URL) command, comprising the steps of:
means for determining a type of said URL command;
test command forming means for adding, according to the determined type, test data to the URL command in order to form a test command; and
a browser for sending said test command to a server and for receiving and displaying returned contents from said server.

10. The testing device according to claim 9, wherein said means of determining the type of said URL command comprises:
decomposing means for decomposing command request code of said URL command;
type determining means for determining, according to a request type obtained by said decomposing means, whether said URL command is a GET type or a POST type.

11. The testing device according to claim 9, wherein said test command forming means comprises:
GET test command forming means for appending, when it is determined that said URL command is a GET type, to the URL command test parameters and a hostname of a corresponding server, piecing them into a URL command which can be directly used as said GET test command by the browser, and loading same to said browser; and
POST test command forming means for submitting, when it is determined that said URL command is a POST type, a POST-type form, into which the test data is placed, to said browser as said POST test command using the application interface of said browser for said POST type.

12. The testing device according to claim 9, further comprising verification means for acquiring said server response content, using an application interface of said browser, to verify by using a display of said browser whether the returned result conforms to the test requirement.

13. The testing device according to claim 12, wherein said verification means performs at least one of URL command verification and Graphical User Interface verification.

14. The testing device according to claim 9, wherein said test command forming means adds test data to form an HTTP request which an XMLHTTPRequest module in said browser can support.

15. The testing device according to claim 14, wherein said browser sends, using said XMLHTTPRequest module, an HTTP request which said XMLHTTPRequest module can support.

16. A scenario testing method for testing said scenario by using Uniform Resource Locator (URL) command testing in combination with Graphical User Interface (GUI) testing, the method comprising the steps of:
splitting said scenario into a plurality of tasks in accordance with different applications, such that each task corresponds to one application of one type;
determining a task type as a URL command test task or a GUI test task for each task;
executing the testing in the sequence of tasks of said scenario, and performing the testing in accordance with the testing method of claim 1 when the task type is said URL command test task;
wherein output data of said task is saved for use with subsequent tasks.

17. The scenario testing method according to claim 16, wherein output data of said task is saved by using at least one of a hash table, context content, and an array.

18. The scenario testing method according to claim 16, further comprising a verification step for verifying at least one of a GUI command response and a URL command response result for the final test result of the scenario testing.

19. A scenario testing system for testing said scenario by using Uniform Resource Locator (URL) command testing in combination with Graphical User Interface (GUI) testing, the system comprising:
task splitting means for splitting said scenario into a plurality of tasks in accordance with different applications, such that each task corresponds to one application of one type;
a task execution engine for determining a task type as a URL command test task or a Graphical User Interface test task for each task, executing the testing in the sequence of tasks of said scenario, and performing the testing, wherein when the task type is said URL command test task the task execution engine performs the testing by
determining a type of a URL command,
according to the determined type, adding test data to the URL command to form a test command,
sending said test command to a server using a browser and receiving contents returned from said server, and
displaying the returned contents using said browser; and
a task context engine for saving output data of said task for use of subsequent tasks.

20. The scenario testing system according to claim 19, wherein said task context engine saves output data of said task by using a hash table, context content or an array.

21. The scenario testing system according to claim 19, further comprising a result verification component for verifying at least one of a GUI and a URL command response result for the final test result of the scenario testing.

22. A computer-readable storage medium comprising computer-readable code that, when executed by a computer, causes the computer to perform the steps of:
determining a type of a URL command;
according to the determined type, adding test data to the URL command to form a test command;
sending said test command to a server using a browser and receiving contents returned from said server; and
displaying the returned contents by said browser.
